(19) United States
(12) Patent Application Publication
(10) Pub. No.: US 2025/0306821 A1
(43) Pub. Date: Oct. 2, 2025

(54) INFORMATION PROCESSING SYSTEM, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Koji TAKAHATA, Kanagawa (JP)

(73) Assignee: FUJIFILM Business Innovation Corp., Tokyo (JP)

(21) Appl. No.: 18/789,639

(22) Filed: Jul. 30, 2024

(30) Foreign Application Priority Data
Mar. 27, 2024 (JP) 2024-052138

(51) Int. Cl. G06F 3/12

(52) U.S. Cl. CPC G06F 3/1234; G06F 3/1208

(57) ABSTRACT

An information processing system includes at least one processor configured to: interrupt continuous printing of a printed material, in a case where a printed material having an inspection result of fail is generated during the continuous printing of plural printed materials while performing quality inspection on the plural printed materials; and resume the continuous printing of the printed material from a resume page designated by a user, in a case where an operation of discharging the failed printed material and a subsequent printed material after the failed printed material, on which a printing process has already been performed, to a removal unit is not completed in time, and the failed printed material and the subsequent printed material are discharged to a body discharge unit.

### CROSS-REFERENCE TO RELATED APPLICATIONS

This application is based on and claims priority under 35 USC 119 from Japanese Patent Application No. 2024-052138 filed Mar. 27, 2024.

### BACKGROUND

### (i) Technical Field

The present invention relates to an information processing system, a non-transitory computer readable medium storing an information processing program, and an information processing method.

### (ii) Related Art

JP2021-165020A discloses an inspection system that inspects the quality of a printed material, the inspection system including an inspection unit that inspects the quality of the printed material based on a comparison between a scan image obtained by scanning the printed material and a standard image, a display control unit that displays a screen for receiving a first mode in which a discharge destination of the printed material is not switched regardless of an inspection result of the printed material, or a second mode in which the discharge destination of the printed material is switched according to the inspection result of the printed material, a reception unit that receives the first mode in which the discharge destination of the printed material is not switched regardless of the inspection result of the printed material, or the second mode in which the discharge destination of the printed material is switched according to the inspection result of the printed material, via the screen, and a control unit that controls the discharge destination of the printed material based on the inspection result obtained by the inspection performed by the inspection unit and the mode received by the reception unit.

JP2022-146528A discloses an inspection device that inspects a printed material by comparing a standard image with a printed material that has been printed, the inspection device including a control unit that exclusively controls, as the inspection mode of the inspection, a mode for switching the paper discharge destination of a printed material in which a defect is found, and an inspection job for inspecting a printed material, with a plurality of printed materials as one set, or an inspection type for inspecting printed materials having an order.

### SUMMARY

Aspects of non-limiting embodiments of the present disclosure relate to an information processing system, a non-transitory computer readable medium storing an information processing program, and an information processing method in which the convenience of a user is improved as compared with a case where a resume position of continuous printing is fixed, when a printed material having an inspection result of fail is generated during the continuous printing of a plurality of printed materials while performing quality inspection on the plurality of printed materials and the continuous printing of the plurality of printed materials is interrupted.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: at least one processor configured to: interrupt continuous printing of a printed material, in a case where a printed material having an inspection result of fail is generated during the continuous printing of a plurality of printed materials while performing quality inspection on the plurality of printed materials; and resume the continuous printing of the printed material from a resume page designated by a user, in a case where an operation of discharging the failed printed material and a subsequent printed material after the failed printed material, on which a printing process has already been performed, to a removal unit is not completed in time, and the failed printed material and the subsequent printed material are discharged to a body discharge unit.

### BRIEF DESCRIPTION OF THE DRAWINGS

Exemplary embodiment(s) of the present invention will be described in detail based on the following figures, wherein:

FIG. 1 is a schematic configuration view showing an image forming system according to a first exemplary embodiment;

FIG. 2 is a block diagram illustrating a hardware configuration of an image forming system according to the first exemplary embodiment;

FIG. 3 is a block diagram showing an example of a functional configuration of an image forming system according to a first exemplary embodiment;

FIG. 4 is a diagram illustrating an operation of the image forming system according to the first exemplary embodiment, and illustrates an example in which a printed material having an inspection result of fail and a subsequent printed material are discharged to a purge tray in a case where the failed printed material is generated;

FIG. 5 is a diagram illustrating an operation of the image forming system according to the first exemplary embodiment, and illustrates an example in which a purge operation of the failed printed material and the subsequent printed material is not completed in time and the failed printed material and the subsequent printed material are discharged to a discharge tray;

FIG. 6 is a diagram showing an error screen and a selection screen for designating a page resume position in a case where an inspection failure occurs on an operation panel of the image forming system according to the first exemplary embodiment;

FIG. 7 is a diagram showing a relationship between a method of checking a failed printed material, removal of a printed material from a discharge tray, a resume page wanted by a user, and a designated resume page in the image forming system according to the first exemplary embodiment;

FIG. 8 is a flowchart showing a flow of information processing of the image forming system according to the first exemplary embodiment;

FIG. 9 is a diagram illustrating an operation of an image forming system of a comparative example;

FIG. 10 is a diagram illustrating the operation of the image forming system of the comparative example;

FIG. 11 is a diagram showing a setting screen for designating a purge on an operation panel of the image forming system of the comparative example; and

FIG. 12 is a diagram showing a relationship between a method of checking a failed printed material, removal of a printed material from a discharge tray, a resume page wanted by a user, and an actual resume page in the image forming system according to the comparative example.

### DETAILED DESCRIPTION

Hereinafter, exemplary embodiments of the present invention will be described in detail with reference to the accompanying drawings. The identical reference numerals are given to the identical or equivalent components and parts in each drawing. In addition, the dimensional ratios in the drawings are exaggerated for convenience of explanation and may differ from the actual ratios.

### First Exemplary Embodiment

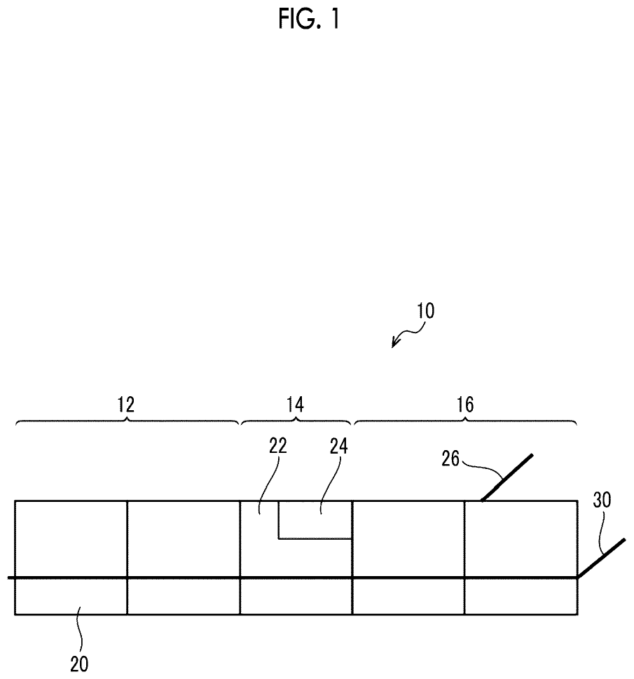

FIG. 1 is a schematic configuration view showing an image forming system 10 according to a first exemplary embodiment.

### Overall Configuration of Image Forming System

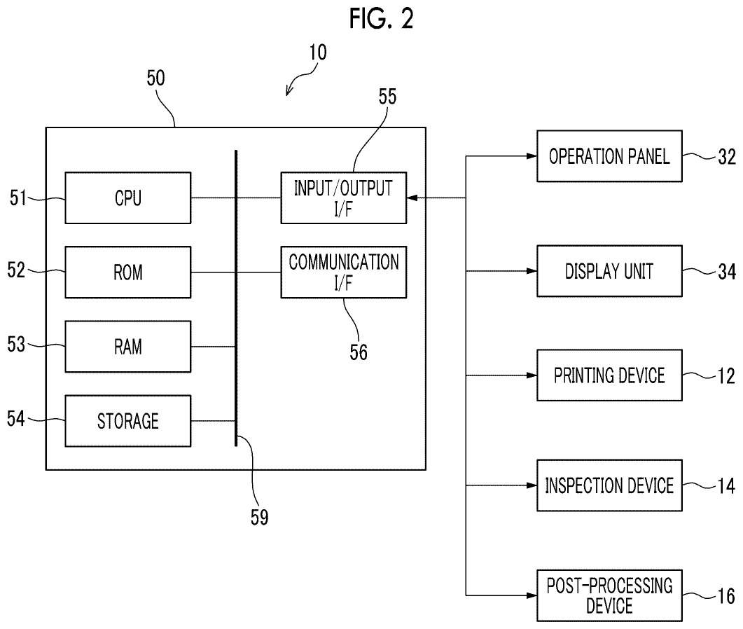

As shown in FIG. 1, an image forming system 10 includes a printing device 12, an inspection device 14, and a post-processing device 16. In addition, the image forming system 10 includes a control device 50 (see FIG. 2) that controls each unit of the image forming system 10. The image forming system 10 is an example of an information processing system.

### Printing Device

The printing device 12 includes an accommodation unit 20 that accommodates the paper. Although not shown, the accommodation unit 20 includes a plurality of accommodation trays that accommodate different types of papers, respectively. The printing device 12 has a printing function of printing an image on the paper supplied from any of the accommodation trays. The paper is an example of a recording medium.

The printing device 12 may be configured to Ide an electrophotographic printing mechanism that prints an image on paper using a toner, or may be configured to include an ink ejection printing mechanism that ejects ink onto paper to form an image. In a case where print data (image data) and various types of operation commands are input from a control device 50 (see FIG. 2), the printing device 12 prints an image on one surface or both surfaces of paper. The printed material on which the image is printed on the paper is supplied to the inspection device 14.

### Inspection Device

The inspection device 14 has an inspection function of receiving the paper on which the image is printed from the printing device 12 and inspecting the printing quality of the received printed paper (that is, printed material). The inspection device 14 determines whether or not there is an abnormality such as corner folding, contamination of printing, or misalignment in the printed material received from the printing device 12. In addition, after the inspection of the printed material, the inspection device 14 supplies the printed material to the post-processing device 16.

Specifically, the inspection device 14 receives a standard image such as a rasterized image generated on the basis of print data (image data) to be printed on the paper, from the printing device 12. In addition, the inspection device 14 includes a scanning unit 22 that optically reads an image of the printed material received from the printing device 12, and an inspection unit 24 that inspects an inspection image, such as a rasterized image, based on the image read by the scanning unit 22. Then, the inspection device 14 collates the standard image received from the printing device 12 with an inspection image based on the image read by the scanning unit 22 and determines whether or not there is an abnormality in the printed material.

After the inspection of the printed material, the inspection device 14 supplies the printed material to the post-processing device 16.

### Post-Processing Device

The post-processing device 16 executes a post-process on the printed material inspected by the inspection device 14. As the post-process, for example, a folding process, a stapling process, a punch hole process, and a booklet manufacturing process are executed. The processing contents of the post-processing device 16 can be changed as appropriate.

In addition, the post-processing device 16 includes a purge tray 26 disposed above the housing of the post-processing device 16 and a discharge tray 30 disposed on a side portion of the housing of the post-processing device 16. The purge tray 26 is an example of a removal unit. The discharge tray 30 is an example of a body discharge unit. In a case where the inspection device 14 determines that there is an abnormality in the printed material, the control device 50 sets the inspection result to fail and discharges the printed material to the purge tray 26. On the other hand, in a case where the inspection device 14 determines that there is no abnormality in the printed material, the control device 50 sets the inspection result to pass and discharges the printed material to the discharge tray 30.

The post-processing device 16 executes a post-process on the printed material and then discharges the printed material to the discharge tray 30. In addition, in a case where the inspection result of the printed material is fail, the post-processing device 16 may discharge the printed material to the purge tray 26 without executing the post-process on the printed material, or may discharge the printed material to the purge tray 26 after executing the post-process on the failed printed material.

### Continuous Printing

The image forming system 10 has a continuous printing function. In this continuous printing, for example, a plurality of continuous printed materials are continuously printed while the printing quality is inspected. Specifically, in the continuous printing, the printing device 12 prints the image on each of the plurality of sheets of paper supplied in sequence from the accommodation unit 20, and the inspection device 14 sequentially inspects the printed material on which the image is printed. In the inspection device 14, the printed material having the inspection result of pass is subjected to post-processing in the post-processing device 16 and is discharged to the discharge tray 30.

### Hardware Configuration of Image Forming System

FIG. 2 is a block diagram showing a hardware configuration of the image forming system 10.

As shown in FIG. 2, the image forming system 10 includes a control device 50. The control device 50 includes various components, such as a central processing unit (CPU) 51, a read only memory (ROM) 52, a random access memory (RAM) 53, a storage 54, an input/output interface (input/output I/F) 55, and a communication interface (communication I/F) 56. The configurations are connected via a bus 59 to communicate with each other.

The CPU 51 is a central processing unit and executes various programs or controls each unit. The CPU 51 is an example of a processor. The CPU 51 reads out a program from the ROM 52 or the storage 54 and executes the program using the RAM 53 as a work area. In the present exemplary embodiment, the information processing program is stored in the ROM 52 or the storage 54. The CPU 51 controls each of the above-described configurations and performs various types of arithmetic processing according to the information processing program recorded on the ROM 52 or the storage 54.

The ROM 52 stores various programs and various data. The RAM 53 temporarily stores a program or data as a work area. The storage 54 is configured by a hard disk drive (HDD) or a solid state drive (SSD), and stores various programs including an operating system and various data.

The input/output interface 55 is an interface for transmitting and receiving information to and from the peripheral device of the control device 50. The input/output interface 55 is connected to each of the operation panel 32, the display unit 34, the printing device 12, the inspection device 14, and the post-processing device 16, and can transmit and receive information with each configuration. In addition, in the image forming system 10 of the present disclosure, instead of this configuration, at least one or more of the operation panel 32, the display unit 34, the printing device 12, the inspection device 14, or the post-processing device 16 may be directly connected via the bus 59.

The communication interface 56 is an interface for communicating with a network, and for example, standards, such as ETHERNET (registered trademark), FDDI, and Wi-Fi (registered trademark), are used for the communication interface 56. The network is, for example, the Internet or a wired or wireless network. As an example, the image forming system 10 is connected to a server (not shown) via the communication interface 56 and can communicate information with the server.

The operation panel 32 displays an operation screen and allows the user to input operations via the operation screen. The operation panel 32 is an example of an input unit. As an example, the operation panel 32 is a touch panel user interface (UI), and is a touch panel display in which a touch panel is superimposed on a liquid crystal display. The user performs an input operation from the operation panel 32 to operate the printing device 12, the inspection device 14, the post-processing device 16, and the like. For example, in the image forming system 10, the operation panel 32 is provided on an upper front side of the housing of the printing device 12.

The display unit 34 displays various types of information. As an example, the display unit 34 is configured with a liquid crystal display larger than the operation panel 32. For example, an inspection result screen indicating an inspection result by the inspection device 14 is displayed on the display unit 34. For example, a scan image of a failed printed material is included in the inspection result screen. Although not shown, for example, the display unit 34 is provided above the housing of the printing device 12.

In the present exemplary embodiment, the operation panel 32 and the display unit 34 are separated from each other, but instead, the operation panel 32 and the display unit 34 may be configured with one member.

### Functional Configuration of Image Forming System

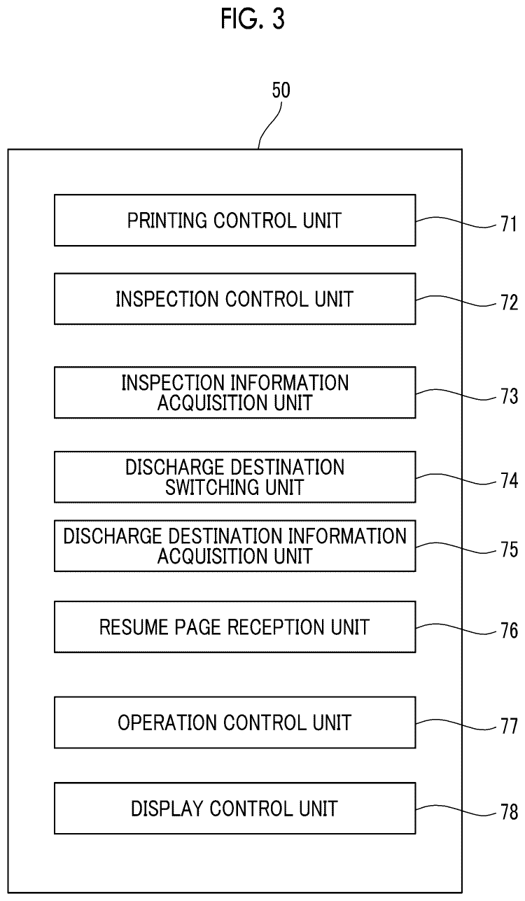

FIG. 3 is a block diagram showing an example of a functional configuration of the image forming system 10.

As shown in FIG. 3, the control device 50 of the image forming system 10 includes a printing control unit 71, an inspection control unit 72, an inspection information acquisition unit 73, a discharge destination switching unit 74, a discharge destination information acquisition unit 75, a resume page reception unit 76, an operation control unit 77, and a display control unit 78 as a functional configuration. Each functional configuration is realized by the CPU 51 reading out the information processing program stored in the ROM 52 or the storage 54, loading the information processing program into the RAM 53, and executing the information processing program.

The printing control unit 71 controls the operation of the printing device 12 (see FIG. 1 and the like). Specifically, the printing control unit 71 acquires printing request information, such as a print image (print data), a paper size, and the number of printed sheets of paper, based on a printing request input from the operation panel 32, and notifies the printing device 12 of the acquired printing request information. In addition, the printing control unit 71 notifies the printing device 12 of the user setting (including the purge information and the resume page information) input from the operation panel 32. Further, the printing control unit 71 transmits an operation instruction to the printing device 12 in accordance with the user setting. The printing device 12 sequentially supplies paper from corresponding accommodation tray of the accommodation unit 20 based on an operation instruction, and performs continuous printing of printing images based on print data on the plurality of papers. The printing device 12 supplies a plurality of printed materials to the inspection device 14.

In addition, in a case where a printed material having an inspection result by the inspection device 14 that is fail is generated during continuous printing, the printing control unit 71 interrupts the continuous printing of the printed material by the printing device 12.

In addition, the printing control unit 71 resumes the continuous printing of the printed material by the printing device 12, based on the resume instruction by the operation panel 32. For example, the printing control unit 71 resumes the continuous printing of the printed material from the position of the resume page designated by the user from the operation panel 32. Here, the user is an example of a user. In addition, the resume page is an example of a resume page designated by the user.

The inspection control unit 72 controls the operation of the inspection device 14 (see FIG. 1 and the like). Specifically, the inspection control unit 72 controls the operations of the scanning unit 22 and the inspection unit 24 in the inspection device 14. The inspection control unit 72 receives the print data transmitted from the printing control unit 71 as the standard image. The inspection control unit 72 transmits an inspection instruction to the inspection device 14 together with the print data (standard image). The inspection device 14 reads the printed material printed by the printing device 12 by the scanning unit 22, and generates an inspection image such as a rasterized image on the basis of the read image. The inspection device 14 executes the inspection of the printed material by the inspection unit 24, based on the inspection instruction of the inspection control unit 72. The inspection unit 24 compares the inspection image with the standard image to determine whether or not there is an abnormality in the printed material, that is, whether the printing quality of the printed material is pass or fail. For example, the inspection unit 24 compares the inspection image with the standard image to determine whether or not there is an abnormality such as a corner folding, printing contamination, or misalignment.

In a case where it is determined that there is no abnormality in the printed material, the inspection unit 24 determines the printed material as pass. In a case where it is determined that there is an abnormality in the printed material, the inspection unit 24 determines the printed material as fail. Information on the inspection result by the inspection unit 24 is transmitted to the inspection control unit 72.

The inspection information acquisition unit 73 acquires information about the inspection result from the inspection control unit 72. Specifically, the inspection information acquisition unit 73 acquires information indicating that the inspection result of the printed material is pass and information indicating that the inspection result of the printed material is fail, as information indicating the inspection result of the printed material, from the inspection unit 24.

The discharge destination switching unit 74 switches the discharge destination of the printed material between the discharge tray 30 and the purge tray 26 based on the information of the inspection result acquired by the inspection information acquisition unit 73. Specifically, the discharge destination switching unit 74 performs an operation of switching a discharge destination of the printed material to one transport path (not shown) in which the discharge destination is the discharge tray 30 and another transport path (not shown) in which the discharge destination is the purge tray 26.

In a case where the inspection result of the printed material by the inspection unit 24 is pass, the discharge destination switching unit 74 switches the discharge destination of the printed material to the discharge tray 30.

On the other hand, in a case where the inspection result of the printed material by the inspection unit 24 is fail, the discharge destination switching unit 74 switches the discharge destination of the failed printed material and a subsequent printed material after the failed printed material, on which a printing process has already been performed, to the purge tray 26.

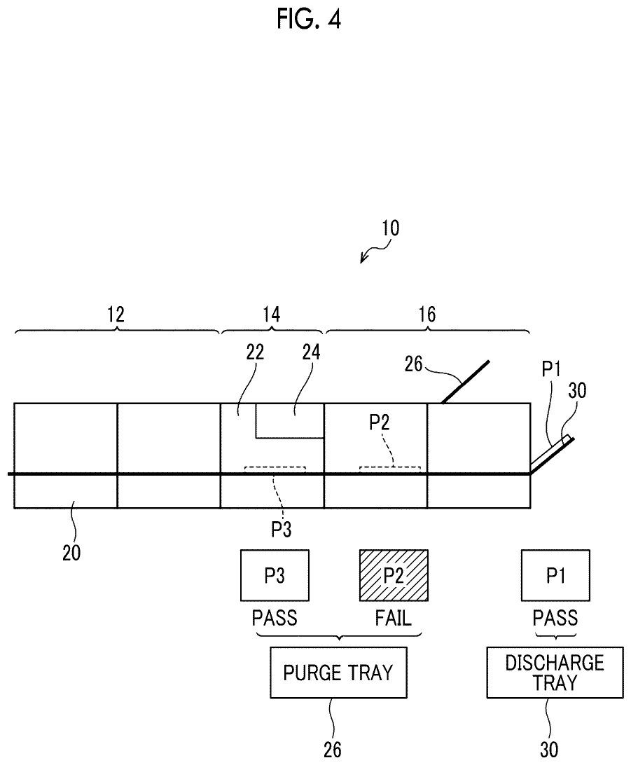

For example, as shown in FIG. 4, in a case where a printed material having an inspection result of fail in the inspection device 14 is generated during continuous printing (printed material of P2), not only the failed printed material but also a subsequent printed material (printed material of P3) after the failed printed material, on which a printing process has already been performed, are discharged to the purge tray 26. The printed material on which the printing process has already been performed includes all the papers in a paper transport path from the accommodation unit 20 to the inspection by the inspection device 14. At the same time, the continuous printing of the printed material in the image forming system 10 is interrupted.

In the example shown in FIG. 4, in a case where the resume instruction is input from the user from the operation panel 32, the continuous printing is resumed from the printed material (printed material of P2) having the inspection result of fail. The printed material for which the inspection result is pass by the quality inspection of the inspection device 14 is discharged to the discharge tray 30. In a case where a printed material having an inspection result of fail is generated in the inspection device 14, only the failed printed material (printed material P2) is discharged to the purge tray 26, and the printed material (printed material P3) after the failed printed material, on which a printing process has already been performed, is discharged to the discharge tray 30, the page order of the printed material is shifted in the discharge tray 30.

The discharge destination information acquisition unit 75 acquires the discharge destination information indicating the discharge destination to which the printed material is actually discharged. Specifically, the discharge destination information acquisition unit 75 acquires the discharge destination information indicating whether the printed material is actually discharged to the discharge tray 30 or the purge tray 26.

For example, a sensor (not shown) for detecting the printed material is provided in each of the discharge tray 30 and the purge tray 26. The discharge destination information acquisition unit 75 acquires information about the printed material actually discharged to the discharge tray 30, by the sensor provided in the discharge tray 30. The information of the printed material actually discharged to the discharge tray 30 includes information on paper on which page the printed material corresponds to, among the plurality of sheets of paper printed by the printing device 12.

In addition, the discharge destination information acquisition unit 75 acquires information about the printed material actually discharged to the purge tray 26 by the sensor provided in the purge tray 26. For example, the information of the printed material actually discharged to the purge tray 26 includes information on paper on which page the printed material corresponds to, among the plurality of sheets of paper printed by the printing device 12.

For example, in a case where the quality inspection of the printed material by the inspection unit 24 takes time and the quality inspection of the printed material is not finished within a predetermined time, the discharge destination of the printed material by the discharge destination switching unit 74 cannot be switched. In addition, switching the discharge destination of the printed material by the discharge destination switching unit 74 involves an operation of switching between the transport paths to the discharge tray 30 and the purge tray 26, and therefore requires an operation time. Therefore, in a case where the inspection result of the printed material by the inspection unit 24 is fail, the operation of switching the discharge destination to the purge tray 26 by the discharge destination switching unit 74 may not be completed in time. In a case where the operation of switching the discharge destination by the discharge destination switching unit 74 is not completed in time, the printed material having the inspection result of fail and a subsequent printed material after the printed material, on which a printing process has already been performed, are discharged to the discharge tray 30. The printing control unit 71 forcibly interrupts the continuous printing.

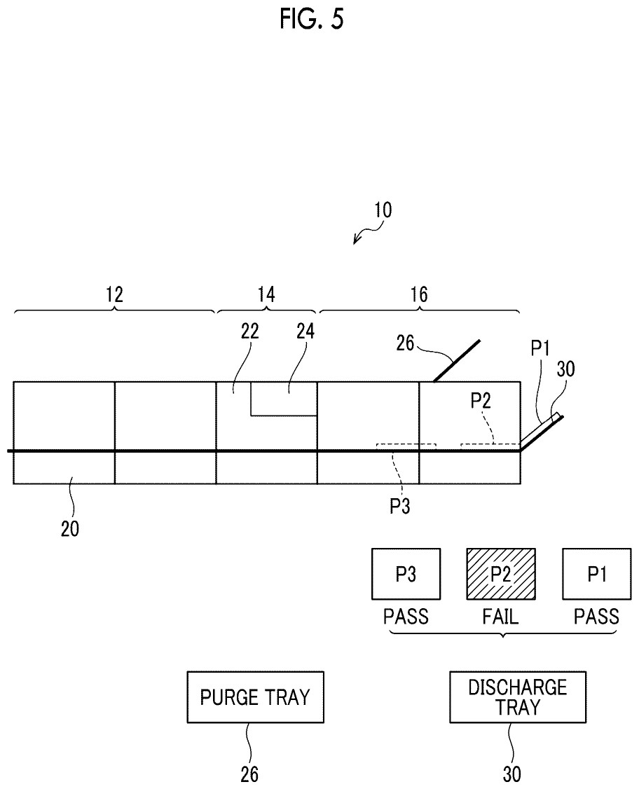

For example, as shown in FIG. 5, in a case where a printed material (printed material of P2) having an inspection result of fail in the inspection device 14 is generated during continuous printing, the operation of switching the discharge destination to the purge tray 26 by the discharge destination switching unit 74 may not be completed in time. In this case, the failed printed material (printed material of P2) and the subsequent printed material (printed material of P3) after the failed printed material, on which a printing process has already been performed, are discharged to the discharge tray 30.

The discharge destination information acquisition unit 75 acquires information about the printed material (printed materials of P1 to P3) actually discharged to the discharge tray 30. As described above, the information of the printed material actually discharged to the discharge tray 30 includes information on paper on which page the printed material corresponds to, among the plurality of sheets of paper printed by the printing device 12.

The resume page reception unit 76 receives the resume page designated by the user. The resume page is a resume position when the continuous printing is resumed by the printing device 12 after the continuous printing is interrupted by the printing device 12.

As an example, the resume page reception unit 76 receives a resume page when the continuous printing by the printing device 12 is resumed by an input operation of the user from the operation panel 32 after the continuous printing by the printing device 12 is interrupted.

The operation control unit 77 controls the operation panel 32. For example, the operation control unit 77 transmits the user setting (including the purge setting) input by the operation panel 32 to the printing control unit 71. For example, the operation control unit 77 displays an error screen in a case where the purging of the failed printed material is not completed in time, an operation screen for the user to input a resume page, or the like on the operation panel 32.

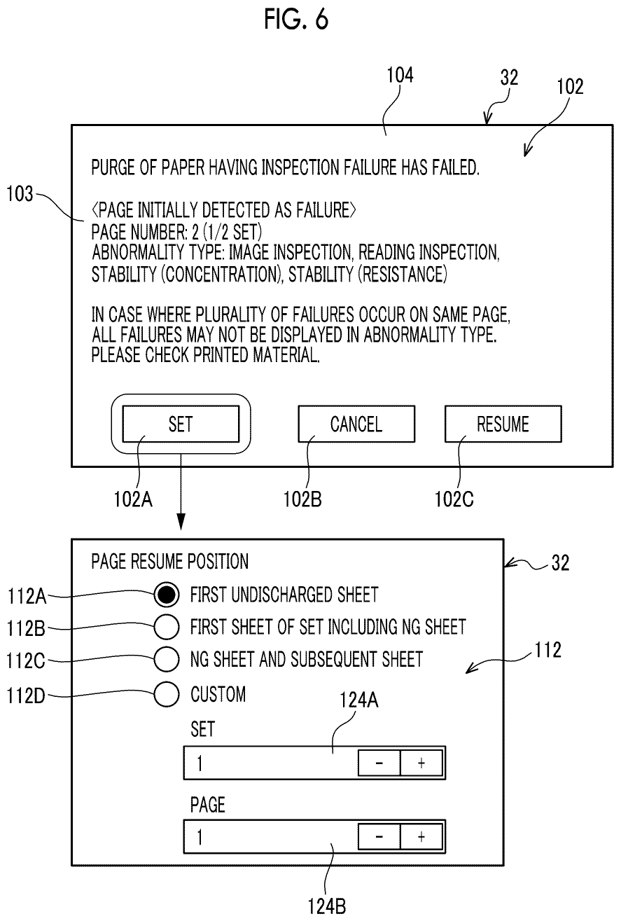

For example, in a case where a printed material (printed material P2) having an inspection result of fail is generated and fails to be discharged to the purge tray 26 (see FIG. 5), as shown in FIG. 6, an error screen 102 related to the inspection failure and the purge failure is displayed on the operation panel 32. The error screen 102 includes inspection failure information 103 indicating a page number (2 page) or the like at which the inspection failure (that is, the failed printed material) has occurred, and purge failure information 104 indicating that the purge has failed. In addition, the error screen 102 includes a setting button 102A for setting the resume page, a cancel button 102B for canceling the continuous printing, and a resume button 102C for resuming the continuous printing.

For example, in a case where the user presses the setting button 102A on the error screen 102, a selection screen 112 for designating the resume page is displayed on the operation panel 32. The selection screen 112 includes, for example, a check portion 112A for selecting “first undischarged sheet”, a check portion 112B for selecting “first sheet of set including NG sheet (inspection failure sheet)”, a check portion 112C for selecting “NG sheet and subsequent sheet”, and a check portion 112D for selecting “custom”. The user can select any one of the check portion 112A, the check portion 112B, the check portion 112C, or the check portion 112D on the selection screen 112.

Here, the sheet is an example of paper. The “first undischarged sheet” is an example of a first page of undischarged pages after the failed printed material and the subsequent printed material discharged to the discharge tray 30. For example, in the example shown in FIG. 5, since a sheet after the failed printed material (printed material of P2) and the subsequent printed material (printed material of P3) discharged to the discharge tray 30 is undischarged, “first undischarged sheet” is the paper of the fourth page (paper of P4). The “first sheet of set including NG sheet” is an example of the first page of the set including the page corresponding to the failed printed material among sets instructed to be printed. For example, in the example shown in FIG. 5, the number of sets instructed to be printed is two, and the first set includes a page corresponding to the failed printed material (printed material of P2), so that the “first sheet of set including NG sheet” is the paper of the first page (paper of P1) which is the first page of the first set. The “NG sheet” is an example of a page corresponding to a failed printed material. For example, in the example shown in FIG. 5, since the failed printed material (printed material of P2) corresponds to the second page, “NG sheet and subsequent sheet” is the paper of the second page (paper of P2) and subsequent paper. That is, in a case where “NG sheet and subsequent sheet” is selected, continuous printing is resumed from the paper of the second page (paper of P2).

The user designates the resume page by selecting any one of the check portion 112A, the check portion 112B, or the check portion 112C on the selection screen 112.

By selecting the check portion 112D of “custom”, the user can designate any set by the first designation portion 124A and can designate any page by the second designation portion 124B. The set and the page designated in custom are an example of any resume page that can be designated by the user. By designating the resume page on the selection screen 112, the resume page reception unit 76 receives the resume page designated by the user, as described above.

For example, on the selection screen 112, the check portion 112A of the first undischarged sheet is selected in the initial setting. For example, in a case where the user presses the resume button 102C without designating the resume page on the selection screen 112 (that is, in a case of the resume instruction), the continuous printing is resumed from the first undischarged sheet (in the example shown in FIG. 6, the paper of P4 that is undischarged).

In addition, when a failed printed material is generated, there is a case where the printed materials of all the pages of a job are discharged to the discharge tray 30, and the number of printed materials having the inspection result of pass does not match the number of discharged printed materials. Although not shown, for example, when a failed printed material is generated at the sixth page, there is a case where the printed materials of nine pages which are all pages of a job are discharged to the discharge tray 30, and the number (eight) of printed materials having the inspection result of pass does not match the number (nine) of discharged printed materials. In this case, the operation control unit 77 may display a screen for receiving an input of the resume operation of the continuous printing on the operation panel 32. Then, continuous printing may be resumed by returning to the page (for example, 6 page) before the last page (for example, 9 page) corresponding to the printed material of the last set among the plurality of printed materials discharged to the discharge tray 30.

The display control unit 78 controls a display screen of the display unit 34. For example, the display control unit 78 displays an inspection result screen, which is a result of the quality inspection by the inspection device 14, on the display unit 34. For example, the display control unit 78 displays, on the display unit 34, the scan image of the failed printed material read by the scanning unit 22 as the inspection result screen.

### Configuration and Problem of Image Forming System of Comparative Example

Here, the configuration and problem of an image forming system of a comparative example will be described.

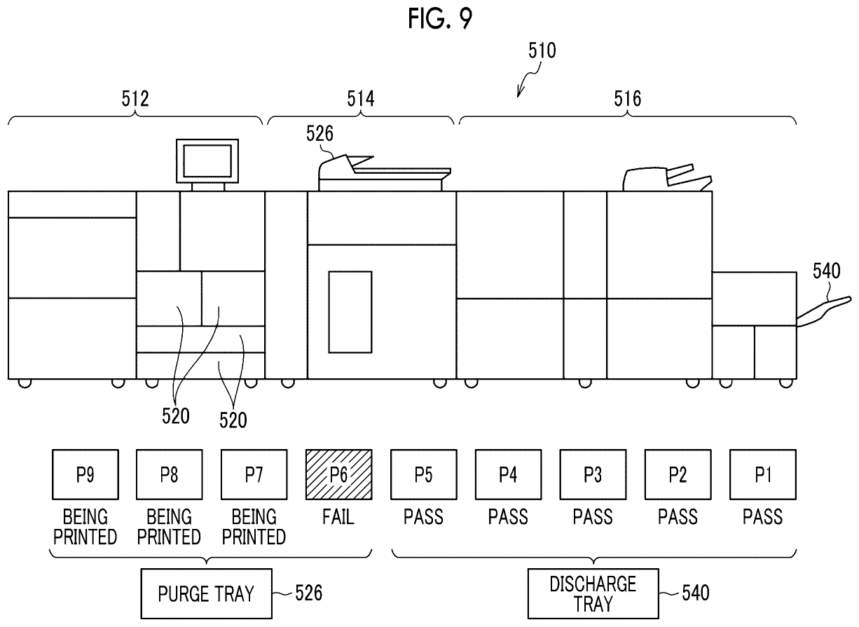

As shown in FIG. 9, an image forming system 510 of a comparative example includes a printing device 512, an inspection device 514, and a post-processing device 516. The printing device 512 includes a plurality of accommodation trays 520 that accommodate paper, and prints an image on the paper supplied from any of the plurality of accommodation trays 520.

The image forming system 510 includes a purge tray 526 disposed above the inspection device 514 and a discharge tray 540 disposed on a side portion of the post-processing device 516. The inspection device 514 performs a quality inspection of the printed material and determines whether the inspection result is pass or fail. The printed material of which the printing result is fail by the inspection device 514 is discharged to the purge tray 526. In addition, the printed material of which the printing result is pass by the inspection device 514 is discharged to the discharge tray 540.

For example, in a case where a printed material having an inspection result of fail in the inspection device 514 is generated (printed material of P6) during continuous printing, the failed printed material and subsequent printed materials (printed materials of P7 to P9) that has already been subjected to the printing process are discharged to the purge tray 526.

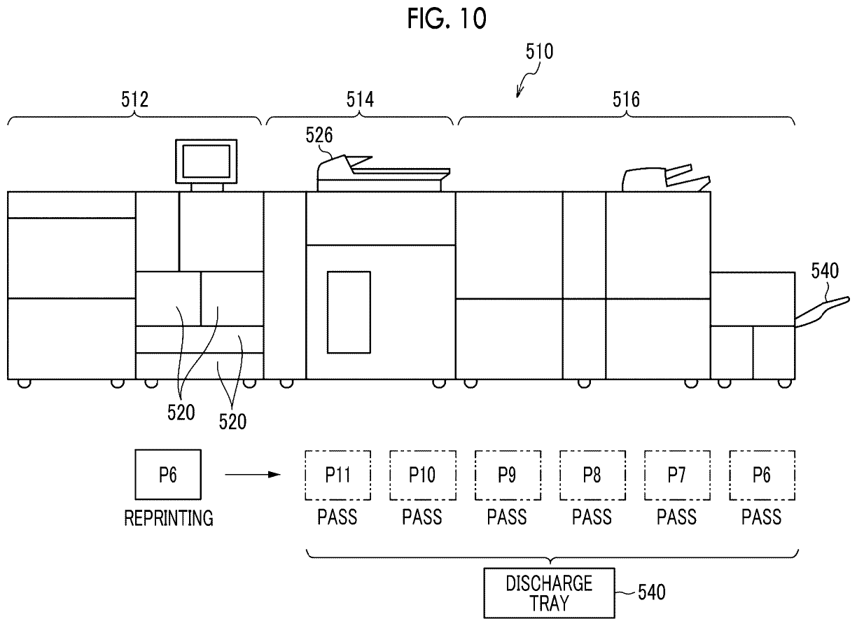

Thereafter, as shown in FIG. 10, the continuous printing (reprinting) is resumed from the printed material (printed material of P6) having the inspection result by the inspection device 514 of fail. Then, as shown by the two-dot chain line in FIG. 10, the printed material (printed material of 6p) having the inspection result by the inspection device 514 of pass and the subsequent printed materials (printed materials of P7 to P11) following the printed material are discharged to the discharge tray 540.

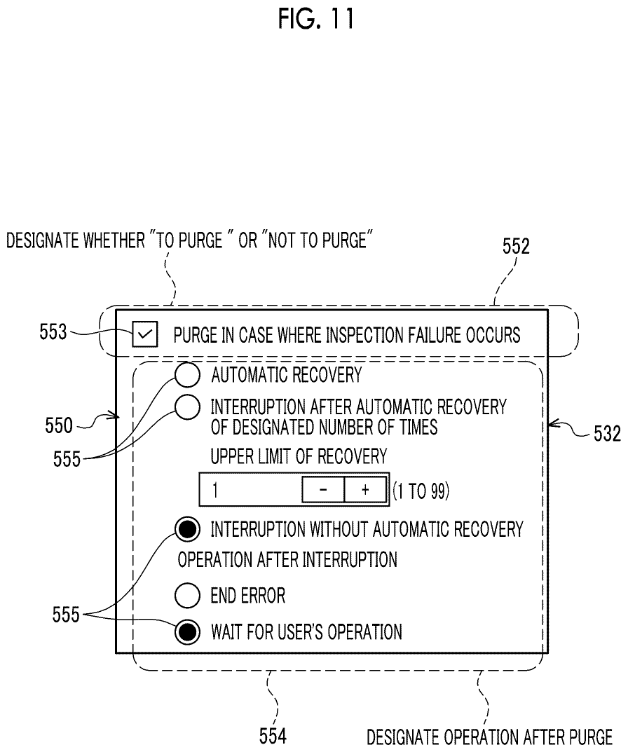

FIG. 11 is a diagram showing a setting screen 550 displayed on the operation panel 532 of the image forming system 510. As shown in FIG. 11, on the setting screen 550, whether or not to perform purging is designated, in a case where a printed material having an inspection result of fail is generated (that is, an inspection failure occurs). A selection box 553 of “Purge” is displayed in an upper region 552 of the setting screen 550. In a case where the selection box 553 is checked, the failed printed material and the subsequent printed material are discharged to the purge tray 526.

When “purge” is designated, a plurality of selection portions 555 for designating the operation after the purge are displayed in a lower region 554 of the setting screen 550. By selecting any of the plurality of selection portions 555, for example, automatic recovery (that is, resumption), interruption without automatic recovery, operation after interruption, and the like can be selected. For example, in the example shown in FIG. 11, “interruption without automatic recovery” is selected, and “wait for user's operation” is selected as the operation after the interruption. Accordingly, in a case where the user performs the operation of the resume instruction, the continuous printing is resumed. The continuous printing is set (that is, fixed) to be resumed from the first sheet of the sheets of paper that are not discharged to the discharge tray 540 (that is, the first sheet of undischarged sheets of paper).

In the image forming system 510, in a case where a printed material having an inspection result of fail is generated in the inspection device 514 during continuous printing, the discharge of the failed printed material to the purge tray 526 may not be completed in time. For example, in a case where a printed material (printed material of P2) having an inspection result of fail is generated, the failed printed material (printed material of P2) and the subsequent printed material (printed material of P3) after the failed printed material, on which a printing process has already been performed, are discharged to the discharge tray 540 (the same as in the example shown in FIG. 5).

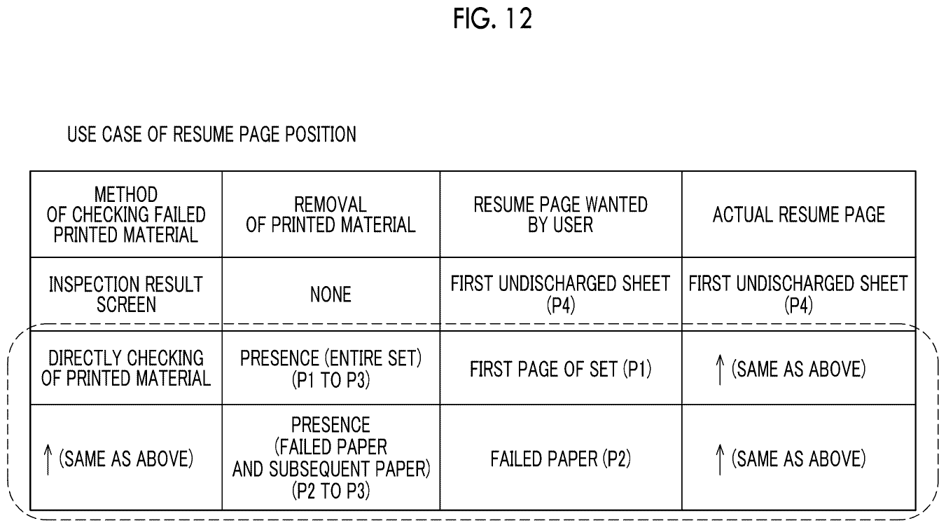

FIG. 12 is a diagram showing a position of a resume page in a case where a failed printed material is generated. As shown in FIG. 12, there are a method of checking an inspection result screen on a display unit (not shown) by a user and a method of directly checking a printed material by the user visually, as a method of checking the failed printed material. In the method of checking the inspection result screen, since the user checks the inspection result screen, there is no printed material to be removed from the discharge tray 540. In the method of directly checking the printed material, the printed material removed from the discharge tray 540 is present. This is for the user to take out the printed material from the discharge tray 540 and visually check the printed material. For example, there is a case where all the printed materials of a set (printed materials of P1 to P3) are removed from the discharge tray 540, and a case where the failed printed material and the subsequent printed material (that is, the printed materials of P2 and P3 which are the failed paper and the subsequent paper) are removed from the discharge tray 540. Here, the term “the failed printed material and the subsequent printed material” refers to printed materials including the failed printed material and a subsequent printed material following the failed printed material (that is, the failed printed material and the printed materials following the failed printed material).

The resume page wanted by the user is the first sheet (paper of P4) of undischarged sheets in a case where the printed material is not removed from the discharge tray 540, but is different in other cases. For example, in a case where all printed materials of the set (printed materials of P1 to P3) are removed from the discharge tray 540, the resume page wanted by the user is the first page (paper of P1) of the set. In addition, in a case where the failed printed material and the subsequent printed material (that is, the printed materials of P2 and P3 of the failed paper and the subsequent paper) are removed from the discharge tray 540, the resume page wanted by the user is the failed paper (paper of P2).

In the image forming system 510, in a case where the user performs the operation of the resume instruction, the continuous printing is fixed to be resumed from the first sheet (paper of P4) of undischarged sheets which are undischarged paper. Therefore, the actual resume page is the first sheet (paper of P4) of undischarged sheets.

As described above, in the image forming system 510, when the continuous printing is resumed, the resume page wanted by the user and the actual resume page may be different from each other. Since the continuous printing is resumed from the first sheet (paper of P4) of undischarged sheets, for example, in a case where the user removes the printed material from the discharge tray 540, there is a problem that the page disorder occurs. Therefore, the user needs to return the printed material taken out from the discharge tray 540 to the discharge tray 540 in order, which is time-consuming.

### Designation of Resume Page

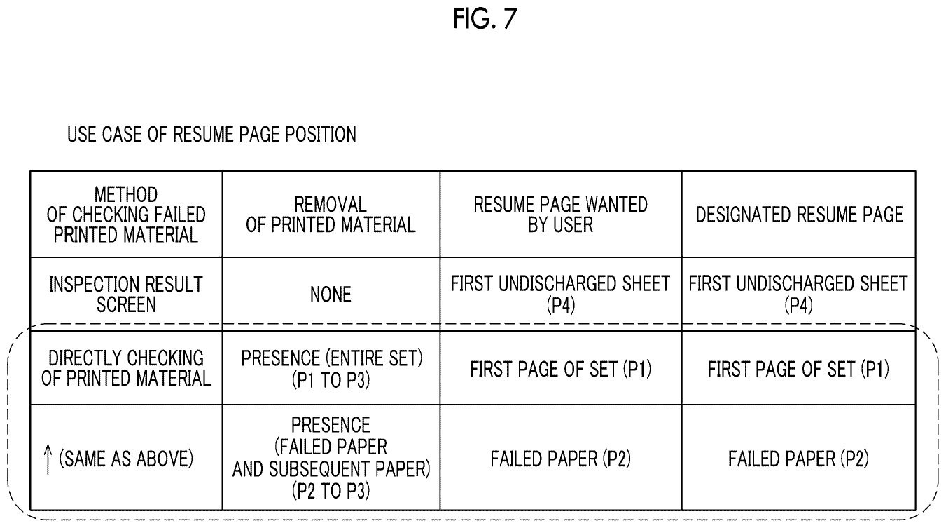

FIG. 7 is a diagram showing an example of a resume page designated by a user in a case where a failed printed material is generated in the image forming system 10 of the first exemplary embodiment.

As shown in FIG. 7, there are a method of checking an inspection result screen displayed on the display unit 34 by a user and a method of directly checking a printed material by the user visually, as a method of checking the failed printed material. In the method of checking the inspection result screen, since the user checks the inspection result screen on the display unit 34, there is no printed material to be removed from the discharge tray 30. In the method of directly checking the printed material, the printed material removed from the discharge tray 30 is present. For example, there is a case where all the printed materials of a set (in the example shown in FIG. 5, the printed materials of P1 to P3) are removed from the discharge tray 540, and a case where the failed paper and the subsequent printed materials (in the example shown in FIG. 5, the failed printed material of P2 and the subsequent printed material of P3) are removed from the discharge tray 540.

In a case where there is no printed material to be removed from the discharge tray 30, the resume page wanted by the user is the first sheet (paper of P4) of undischarged sheets. In this case, the user can designate the position of the resume page as the first sheet (paper of P4) of undischarged sheets on the selection screen 112 of the operation panel 32. In a case where all printed materials of the set (printed materials of P1 to P3) are removed from the discharge tray 540, the resume page wanted by the user is the first page (paper of P1) of the set. In this case, the user can designate the position of the resume page as the first page of the set (paper of P1) of on the selection screen 112 of the operation panel 32. In addition, in a case where the failed paper and the subsequent printed materials (that is, the failed printed material of P2 and the subsequent printed material of P3) are removed from the discharge tray 540, the resume page wanted by the user is the failed paper (paper of P2). In this case, the user can designate the position of the resume page as the failed paper (paper of P2), on the selection screen 112 of the operation panel 32.

### Action of First Exemplary Embodiment

Next, an action of the image forming system 10 of the first exemplary embodiment will be described.

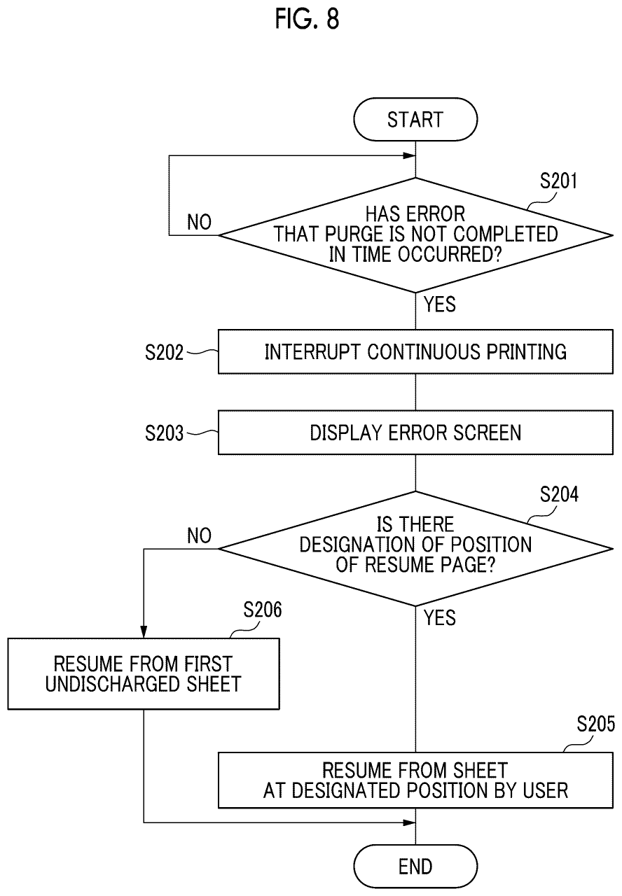

FIG. 8 is a flowchart showing a flow of an information process performed by the control device 50 of the image forming system 10 of the first exemplary embodiment. In the image forming system 10, the CPU 51 reads out the information processing program for generating reference information from the ROM 52 or the storage 54, loads the information processing program into the RAM 53, and executes the information processing program, so that the information process is performed.

In the image forming system 10, in a case where an operation of performing continuous printing while performing a quality inspection on a plurality of printed materials is started, the following information process is performed.

The CPU 51 determines whether or not an error that the purge is not completed in time has occurred (step S201). Specifically, in a case where a printed material having an inspection result of fail is generated via the quality inspection of the printed material by the inspection device 14 and the discharge of the failed printed material to the purge tray 26 is not completed in time, the CPU 51 determines that an error occurs. For example, as shown in FIG. 5, in a case where a printed material (printed material of P2) having an inspection result of fail is generated, a purge operation is not completed in time, and the failed printed material and a subsequent printed materials (printed materials of P2 and P3) on which the printing process has already been performed are discharged to the discharge tray 30, the CPU 51 determines that an error has occurred.

In a case where an error that the purge is not completed in time does not occur (step S201: NO), the CPU 51 waits until the error that the purge is not completed in time occurs.

In a case where an error that the purge is not completed in time occurs (step S201: YES), the CPU 51 interrupts the continuous printing (step S202).

The CPU 51 displays an error screen on the operation panel 32 (step S203). For example, in a case where a failed printed material (printed material of P2) is generated and fails to be discharged to the purge tray 26 (see FIG. 5), the CPU 51 displays an error screen 102 on the operation panel 32 as shown in FIG. 6. The error screen 102 includes inspection failure information 103 indicating a page number or the like at which a failed printed material (printed material of P2) is generated, and purge failure information 104 indicating that the purge has failed. The user can check a scanned image or the like of the failed printed material (printed material of P2) on the display unit 34, based on the inspection failure information 103 displayed on the error screen 102.

The CPU 51 determines whether or not there is a designation of the position of the resume page (step S204). For example, as shown in FIG. 6, in a case where the user presses the setting button 102A, the selection screen 112 is displayed on the operation panel 32. In a case where the user designates the resume page on the selection screen 112, the CPU 51 determines that there is a designation of the position of the resume page. On the selection screen 112, the user can designate a resume page on which the user wants to resume continuous printing (see FIG. 7).

In a case where the position of the resume page is designated (step S204: YES), the CPU 51 resumes continuous printing from the sheet at the designated position by the user (step S205). For example, in a case where the user selects the check portion 112C on the selection screen 112, the continuous printing is resumed from the sheet of the second page (paper of P2) corresponding to the failed printed material (printed material of P2).

In a case where the position of the resume page is not designated (step S204: NO), the CPU 51 resumes continuous printing from the first undischarged sheet (step S206). For example, on the error screen 102, in a case where the user presses the resume button 102C without pressing the setting button 102A, the first undischarged sheet is selected as the initial setting. In the example shown in FIG. 5, the fourth page after the printed materials (printed materials P1 to P3) discharged to the discharge tray 30 is the first undischarged sheet. Therefore, the continuous printing is resumed from the sheet of the fourth page (paper of P4). Thus, a process based on the information processing program performed by the control device 50 of the image forming system 10 is ended.

In the flowchart shown in FIG. 8, in a case where an error that the purge is not completed in time occurs, the CPU 51 interrupts the continuous printing. Instead of this, in a case where a printed material having an inspection result of fail is generated, the CPU 51 may interrupt the continuous printing, and in a case where an error that the purge is not completed in time occurs, the CPU 51 may display an error screen.

In the image forming system 10, in a case where a printed material having an inspection result of fail is generated during continuous printing of a plurality of printed materials while performing the quality inspection, the CPU 51 interrupts the continuous printing of the printed material. In a case where the operation of discharging the failed printed material and the subsequent printed material on which the printing process has already been performed to the purge tray 26 is not completed in time and the failed printed material and the subsequent printed material are discharged to the discharge tray 30, the CPU 51 resumes the continuous printing of the printed material from the page resume position designated by the user.

Therefore, in the image forming system 10, the convenience of the user is improved as compared with a case where a resume position of the continuous printing is fixed, when a printed material having an inspection result of fail is generated during the continuous printing of a plurality of printed materials while performing quality inspection on the plurality of printed materials and the continuous printing is interrupted.

For example, in the comparative example shown in FIG. 12, the resume page is fixed to the first undischarged sheet, and thus the resume page may be different from the resume page wanted by the user. On the other hand, in the image forming system 10, since the user designates the resume page (see FIG. 7), the continuous printing can be resumed from the resume page wanted by the user. Therefore, even in a case where the user removes a part of the printed material from the discharge tray 30, page disorder is unlikely to occur. In addition, since the user can adjust the resume page of the continuous printing without returning the printed material removed from the discharge tray 30 to the corresponding position of the discharge tray 30, the convenience of the user is improved.

In addition, the image forming system 10 includes an operation panel 32 for inputting a resume page. The CPU 51 receives a resume page by an input of the user from the operation panel 32, after the continuous printing is interrupted. Therefore, in the image forming system 10, the convenience of the user is improved as compared with a case where the user designates the resume page in advance before the continuous printing is interrupted.

In addition, in the image forming system 10, the CPU 51 displays, on the operation panel 32, a selection screen in which any one of a first page of undischarged pages after the failed printed material and the subsequent printed material that are discharged to the discharge tray 30, a page corresponding to the failed print material, or a first page of a set including a page corresponding to the failed printed material among the sets instructed to be printed is selectable as the resume page. For example, the CPU 51 displays the selection screen 112 shown in FIG. 6 on the operation panel 32, so that all the resume pages described above can be designated. Therefore, in the image forming system 10, the user can easily designate the resume page as compared with a case where the user inputs only any page.

In addition, in the image forming system 10, in a case where the user gives a resume instruction without designating the resume page, the CPU 51 resumes continuous printing from the first page of undischarged pages after the failed printed material and the subsequent printed material discharged to the discharge tray 30 as the initial setting. The first page of the undischarged pages has the same meaning as the first undischarged sheet, for example (see FIG. 6). Therefore, in the image forming system 10, the convenience of the user is improved as compared with a case where the user designates the resume page each time when the continuous printing is interrupted.

In addition, in the image forming system 10, the CPU 51 receives any resume page input by the user. Therefore, the image forming system 10 may flexibly respond to the user's preference, as compared with a case of selecting one page from only the plurality of resume pages presented.

In addition, in the image forming system 10, the CPU 51 displays information about the failed printed material on the display unit 34. Therefore, in the image forming system 10, the user may designate the resume page without looking at the failed printed material discharged to the discharge tray 30.

In addition, in the image forming system 10, the CPU 51 displays a screen for receiving an input of a resume operation of the continuous printing on the operation panel 32, in a case where printed materials of all pages of a job are discharged to the discharge tray 30, and the number of printed materials having the inspection result of pass does not match the number of discharged printed materials, when the failed printed material is generated. Therefore, in the image forming system 10, in a case where the number of printed materials having the inspection result of pass does not match the number of discharged printed materials in the discharge tray 30, the convenience of the user is improved as compared with a case where the continuous printing is always executed from the first page.

In addition, in the image forming system 10, continuous printing is resumable by returning to a page before the last page corresponding to the printed material of the last set among the plurality of printed materials discharged onto the discharge tray 30. Therefore, in the image forming system 10, the convenience of the user is improved as compared with a case where the continuous printing is always executed from the first page.

In addition, in the image forming system 10, in a case where the operation of discharging the failed printed material and the subsequent printed material on which the printing process has already been performed to the purge tray 26 is not completed in time, the CPU 51 discharges the failed printed material and the subsequent printed material to the discharge tray 30. Further, after receiving the resume instruction of the user, the CPU 51 resumes the continuous printing of the printed material from the resume page designated by the user. Therefore, in the image forming system 10, the convenience of the user is improved, as compared with a case where continuous printing is immediately resumed from the resume page designated by the user.

### Others

The information processing system according to the present disclosure is not limited to the image forming system 10 described in the first exemplary embodiment, and may be changed in various ways.

The process of the image forming system 10 can also be implemented by a dedicated hardware circuit. In this case, the process may be executed by one hardware or may be executed by a plurality of pieces of hardware.

In addition, the program for operating the image forming system 10 may be provided by a computer-readable recording medium such as a Universal Serial Bus (USB) memory, a flexible disk, or a Compact Disc Read Only Memory (CD-ROM), or may be provided online via a network such as the Internet. In this case, the program recorded on the computer-readable recording medium is usually transferred to a memory, a storage, or the like and stored. In addition, for example, the program may be provided as independent application software, or may be incorporated into software of each device as a function of the image forming system 10.

It should be noted that, although the present invention has been described in detail with respect to specific exemplary embodiments, the present invention is not limited to such exemplary embodiments, and it will be apparent to a person skilled in the art that various other exemplary embodiments are possible within the scope of the present invention.

### Supplementary Note

Further, the following supplementary notes will be disclosed with respect to the above exemplary embodiments.
(((1)))

An information processing system comprising:
at least one processor configured to:
   interrupt continuous printing of a printed material, in a case where a printed material having an inspection result of fail is generated during the continuous printing of a plurality of printed materials while performing quality inspection on the plurality of printed materials; and
   resume the continuous printing of the printed material from a resume page designated by a user, in a case where an operation of discharging the failed printed material and a subsequent printed material after the failed printed material, on which a printing process has already been performed, to a removal unit is not completed in time, and the failed printed material and the subsequent printed material are discharged to a body discharge unit.
(((2)))

The information processing system according to (((1))) further comprising:
an input unit that inputs the resume page,
wherein the processor is configured to:
   receive the resume page by an input from the input unit by the user, after the continuous printing is interrupted.
(((3)))

The information processing system according to (((2))), wherein the processor is configured to:
display, on the input unit, a selection screen in which any one of a first page of undischarged pages after the failed printed material and the subsequent printed material that are discharged to the body discharge unit, a page corresponding to the failed print material, or a first page of a set including the page corresponding to the failed printed material among sets instructed to be printed is selectable as the resume page.
(((4)))

The information processing system according to (((3))), wherein the processor is configured to:
resume the continuous printing from the first page of the undischarged pages after the failed printed material and the subsequent printed material that are discharged to the body discharge unit, as an initial setting, in a case where the user gives a resume instruction without designating the resume page.
(((5)))

The information processing system according to (((2))), wherein the processor is configured to:
receive any resume page by the user.
(((6)))

The information processing system according to (((5))), wherein the processor is configured to:
display information about the failed printed material on a display unit.
(((7)))

The information processing system according to any one of (((1))) to (((6))), wherein the processor is configured to:
display a screen for receiving an input of a resume operation of the continuous printing on an input unit, in a case where printed materials of all pages of a job are discharged to the body discharge unit, and the number of printed materials having the inspection result of pass does not match the number of discharged printed materials, when the failed printed material is generated.
(((8)))

The information processing system according to (((7))),
wherein the continuous printing is resumable by returning to a page before a last page corresponding to a printed material of a last set, among the plurality of printed materials discharged to the body discharge unit.
(((9)))

The information processing system according to any one of (((1))) to (((8))), wherein the processor is configured to:

discharge the failed printed material and the subsequent printed material to the body discharge unit, in a case where the operation of discharging the failed printed material and the subsequent printed material to the removal unit is not completed in time; and
resume the continuous printing of the printed material from the resume page, after receiving a resume instruction from the user.
(((10)))

An information processing program causing a computer to execute a process comprising:
interrupting continuous printing of a printed material, when a printed material having an inspection result of fail is generated during the continuous printing of a plurality of printed materials while performing quality inspection on the plurality of printed materials; and
resuming the continuous printing of the printed material from a resume page designated by a user, in a case where an operation of discharging the failed printed material and a subsequent printed material after the failed printed material, on which a printing process has already been performed, to a removal unit is not completed in time, and the failed printed material and the subsequent printed material are discharged to a body discharge unit.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
at least one processor configured to:
interrupt continuous printing of a printed material, in a case where a printed material having an inspection result of fail is generated during the continuous printing of a plurality of printed materials while performing quality inspection on the plurality of printed materials; and
resume the continuous printing of the printed material from a resume page designated by a user, in a case where an operation of discharging the failed printed material and a subsequent printed material after the failed printed material, on which a printing process has already been performed, to a removal unit is not completed in time, and the failed printed material and the subsequent printed material are discharged to a body discharge unit.

2. The information processing system according to claim 1, further comprising:
an input unit that inputs the resume page,
wherein the processor is configured to:
receive the resume page by an input from the input unit by the user, after the continuous printing is interrupted.

3. The information processing system according to claim 2, wherein the processor is configured to:
display, on the input unit, a selection screen in which any one of a first page of undischarged pages after the failed printed material and the subsequent printed material that are discharged to the body discharge unit, a page corresponding to the failed print material, or a first page of a set including the page corresponding to the failed printed material among sets instructed to be printed is selectable as the resume page.

4. The information processing system according to claim 3, wherein the processor is configured to:
resume the continuous printing from the first page of the undischarged pages after the failed printed material and the subsequent printed material that are discharged to the body discharge unit, as an initial setting, in a case where the user gives a resume instruction without designating the resume page.

5. The information processing system according to claim 2, wherein the processor is configured to:
receive any resume page by the user.

6. The information processing system according to claim 5, wherein the processor is configured to:
display information about the failed printed material on a display unit.

7. The information processing system according to claim 1, wherein the processor is configured to:
display a screen for receiving an input of a resume operation of the continuous printing on an input unit, in a case where printed materials of all pages of a job are discharged to the body discharge unit, and the number of printed materials having the inspection result of pass does not match the number of discharged printed materials, when the failed printed material is generated.

8. The information processing system according to claim 7,
wherein the continuous printing is resumable by returning to a page before a last page corresponding to a printed material of a last set, among the plurality of printed materials discharged to the body discharge unit.

9. The information processing system according to claim 1, wherein the processor is configured to:
discharge the failed printed material and the subsequent printed material to the body discharge unit, in a case where the operation of discharging the failed printed material and the subsequent printed material to the removal unit is not completed in time; and
resume the continuous printing of the printed material from the resume page, after receiving a resume instruction from the user.

10. A non-transitory computer readable medium storing an information processing program causing a computer to execute a process comprising:
interrupting continuous printing of a printed material, when a printed material having an inspection result of fail is generated during the continuous printing of a plurality of printed materials while performing quality inspection on the plurality of printed materials; and
resuming the continuous printing of the printed material from a resume page designated by a user, in a case where an operation of discharging the failed printed material and a subsequent printed material after the failed printed material, on which a printing process has already been performed, to a removal unit is not completed in time, and the failed printed material and the subsequent printed material are discharged to a body discharge unit.

11. An information processing method comprising:
interrupting continuous printing of a printed material, when a printed material having an inspection result of fail is generated during the continuous printing of a plurality of printed materials while performing quality inspection on the plurality of printed materials; and
resuming the continuous printing of the printed material from a resume page designated by a user, in a case where an operation of discharging the failed printed material and a subsequent printed material after the failed printed material, on which a printing process has already been performed, to a removal unit is not completed in time, and the failed printed material and the subsequent printed material are discharged to a body discharge unit.
